(19) United States
(12) Patent Application Publication
(10) Pub. No.: US 2015/0035211 A1
(43) Pub. Date: Feb. 5, 2015

(54) GAS SPRING AND COMPONENT ASSEMBLY AS WELL AS METHODS OF ASSEMBLY

(71) Applicant: Firestone Industrial Products Company, LLC, Indianapolis, IN (US)

(72) Inventor: Paul P. Koeske, Fishers, IN (US)

(21) Appl. No.: 14/383,696

(22) PCT Filed: Mar. 9, 2013
(86) PCT No.: PCT/US13/30083

§ 371 Date: Sep. 8, 2014

Related U.S. Application Data
(60) Provisional application No. 61/608,996, filed on Mar. 9, 2012.

(51) Int. Cl. B60G 11/27; B60G 11/28; F16F 9/05

(52) U.S. Cl. CPC B60G 11/27; F16F 9/05; B60G 11/28; B60G 2206/80; B60G 2202/152; B60G 2204/126
USPC 267/64.27; 29/896.9

(57) ABSTRACT

A gas spring and component assembly includes a flexible wall and an end member secured across an end of the flexible wall. The end member can include an end member wall with a first surface disposed toward the flexible wall and a second surface facing away from the flexible wall. A component can be secured along the the second surface of the end member. An embedded end member and can include a component wall with a first surface disposed along one of the first surface and fastener connection can be formed between the end member and the component and can secure the end member and the component in fixed relation to one another. Methods of assembling a gas spring assembly and methods of assembling a suspension system are also included.

### BACKGROUND

The subject matter of the present disclosure broadly relates to the art of gas spring devices and, more particularly, to a gas spring and component assembly that includes a gas spring with at least one end member and a component secured along an end member of the gas spring using a connection formed by a cold joining process. Such a gas spring and component assembly can be included in or otherwise form a part of a suspension system. Methods of assembly are also included.

The subject matter of the present disclosure may find particular application and use as or otherwise in conjunction with components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles, support structures, height adjusting systems and actuators associated with industrial machinery, components thereof and/or other such equipment. Accordingly, the subject matter of the present disclosure is not intended to be limited to use associated with gas spring suspension systems of wheeled vehicles.

Wheeled motor vehicles of most types and kinds include a sprung mass, such as a body or chassis, for example, and an unsprung mass, such as two or more axles or other wheel-engaging members, for example, with a suspension system disposed therebetween. Typically, a suspension system will include a plurality of spring devices as well as a plurality of damping devices that together permit the sprung and unsprung masses of the vehicle to move in a somewhat controlled manner relative to one another. Movement of the sprung and unsprung masses toward one another is normally referred to in the art as jounce motion while movement of the sprung and unsprung masses away from one another is commonly referred to in the art as rebound motion.

Gas spring assemblies are commonly secured on, along or otherwise between the sprung and unsprung masses in a variety of ways and using a wide range of components. Generally, the range of motion of a suspension system extends between a first or fully compressed condition and a second or fully extended condition. To retain the one or more gas spring assemblies in operative association the sprung and unsprung masses, each end of the one or more gas spring assemblies is typically secured on or along opposing structural members of the associated sprung and unsprung masses (e.g., opposing components of a suspension system). As such, conventional gas spring end members commonly include one or more brackets or other components that can be used to orient, position, attach and/or otherwise operatively associate the end members with the opposing structural members of the associated sprung and unsprung masses. Typically, such one or more brackets or other components are removably secured on or along the associated end member using one or more threaded fasteners.

Notwithstanding the wide usage of conventional threaded fasteners and the overall success of known assembly techniques for securing gas spring end members to associated structural components, it is believed to be desirable to develop new constructions, designs and/or assembly techniques that are capable of advancing the art of gas spring devices.

### BRIEF SUMMARY

One example of a gas spring and component assembly in accordance with the subject matter of the present disclosure can include a flexible wall having a longitudinal axis and extending peripherally about the axis between a first end and a second end spaced longitudinally from the first end. The flexible wall can be dimensioned to at least partially define a spring chamber. An end member can be secured across the first end of the flexible wall. The end member can include an end member wall with a first surface disposed toward the flexible wall and a second surface facing away from the flexible wall. A component can include a component wall with a first surface disposed along one of the first surface and the second surface of the end member. An embedded fastener connection can be formed between the end member and the component. The embedded fastener connection can secure the end member and the component in fixed relation to one another.

One example of a method of assembling a gas spring and component assembly in accordance with the subject matter of the present disclosure can include providing an end member that includes an end member wall with a first surface and a second surface opposite the first surface. The method can also include providing a component that includes a component wall with at least a first surface. The method can also include orienting the end member and the component such that the first surface of the component wall is disposed along one of the first surface and the second surface of the end member wall. The method can further include forming an embedded fastener connection between the end member and the component and thereby securing the end member and the component in fixed relation to one another.

One example of a method of assembling a suspension system in accordance with the subject matter of the present disclosure can include providing at least one structural member and providing a gas spring and component assembly including an end member, a component and an embedded fastener connection according to the subject matter of the present disclosure. The method can also include positioning the end member of said gas spring and component assembly adjacent the at least one structural member. The method can further include securing at least the component of the gas spring and component assembly to the at least one structural member.

### BRIEF DESCRIPTION OF THE DRAWINGS

FIG. 1 is a schematic representation of one example of a suspension system of an associated vehicle including gas spring and component assemblies in accordance with the subject matter of the present disclosure.

FIG. 2 is a side view of one example of a gas spring and component assembly in accordance with the subject matter of the present disclosure.

FIG. 3 is a top plan view of the gas spring and component assembly in FIG. 2.

FIG. 4 is a cross-sectional side view of the gas spring and component assembly in FIGS. 2 and 3 taken from along line 4-4 in FIG. 3.

FIGS. 5-10 illustrate one example of a method of assembling a gas spring and component assembly in accordance with the subject matter of the present disclosure.

### DETAILED DESCRIPTION

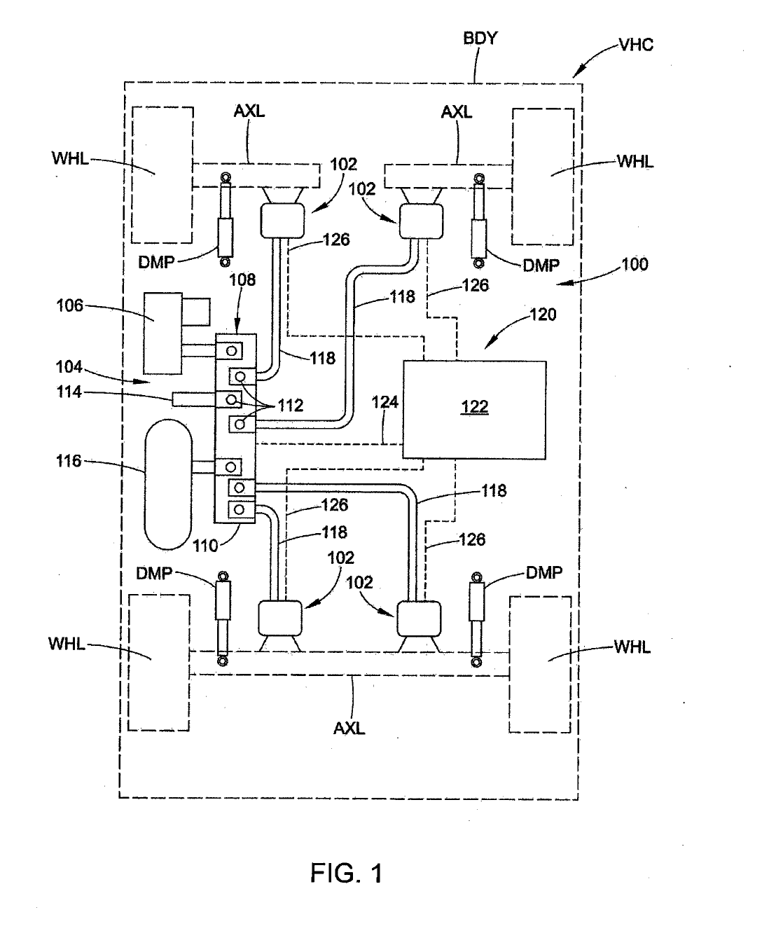

Turning now to the drawings, wherein the showings illustrate examples of the subject matter of the present disclosure and which are not to be considered limiting, FIG. 1 illustrates one example of a suspension system 100 disposed between a sprung mass, such as an associated vehicle body BDY, for example, and an unsprung mass, such as an associated wheel WHL or an associated axle AXL, for example, of an associated vehicle VHC. It will be appreciated that any one or more of the components of the suspension system can be operatively connected between the sprung and unsprung masses of the associated vehicle in any suitable manner. Additionally, it will also be appreciated that such a suspension system of the vehicle can also optionally include a plurality of damping members, such as dampers DMP, for example, and that any such damping members can also be operatively connected between the sprung and unsprung masses of the associated vehicle in any suitable manner.

The suspension system can also include a plurality of gas spring and component assemblies supported between the sprung and unsprung masses of the associated vehicle. In the arrangement shown in FIG. 1, suspension system 100 includes four gas spring and component assemblies 102, one of which is disposed toward each corner of the associated vehicle adjacent a corresponding wheel WHL. However, it will be appreciated that any other suitable number of gas spring and component assemblies could alternately be used in any other configuration or arrangement. As shown in FIG. 1, gas spring and component assemblies 102 are supported between axles AXL and body BDY of associated vehicle VHC. Additionally, it will be recognized that the gas spring and component assemblies shown and described in FIG. 1 (e.g., gas spring assemblies 102) are illustrated as being of a rolling lobe-type construction. It is to be understood, however, that gas spring and component assemblies of any other type, kind and/or construction could alternately be used.

Suspension system 100 also includes a pressurized gas system 104 operatively associated with the gas spring and component assemblies for selectively supplying pressurized gas (e.g., air) thereto and selectively transferring pressurized gas therefrom. In the exemplary embodiment shown in FIG. 1, pressurized gas system 104 includes a pressurized gas source, such as a compressor 106, for example, for generating pressurized air or other gases. A control device, such as a valve assembly 108, for example, is shown as being in communication with compressor 106 and can be of any suitable configuration and/or arrangement. In the exemplary embodiment shown, valve assembly 108 includes a valve block 110 with a plurality of valves 112 supported thereon. Valve assembly 108 can also optionally include a suitable exhaust, such as a muffler 114, for example, for venting pressurized gas from the system. Optionally, pressurized gas system 104 can also include a reservoir 116 in fluid communication with the compressor and/or valve assembly 108 and suitable for storing pressurized gas.

Valve assembly 108 is in communication with gas spring and component assemblies 102 through suitable gas transfer lines 118. As such, pressurized gas can be selectively transferred into and/or out of the gas spring and component assemblies through valve assembly 108 by selectively operating one or more of valves 112, such as to alter or maintain vehicle height at one or more corners of the vehicle, for example.

Suspension system 100 can also include a control system 120 that is capable of communication with any one or more systems and/or components (not shown) of vehicle VHC and/or suspension system 100, such as for selective operation and/or control thereof. Control system 120 can include a controller or electronic control unit (ECU) 122 communicatively coupled with compressor 106 and/or valve assembly 108, such as through a conductor or lead 124, for example, for selective operation and control thereof, which can include supplying and exhausting pressurized gas to and/or from gas spring and component assemblies 102. Controller 122 can be of any suitable type, kind and/or configuration.

Control system 120 can also, optionally, include one or more height (or distance) sensing devices (not shown in FIG. 1), such as, for example, may be operatively associated with the gas spring and component assemblies and capable of outputting or otherwise generating data, signals and/or other communications having a relation to a height of the gas spring and component assemblies or a distance between other components of the vehicle. Such height sensing devices can be in communication with ECU 122, which can receive the height or distance signals therefrom. The height sensing devices can be in communication with ECU 122 in any suitable manner, such as through conductors or leads 126, for example. Additionally, it will be appreciated that the height sensing devices can be of any suitable type, kind and/or construction.

A gas spring and component assembly in accordance with the subject matter of the present disclosure can include a gas spring (which may be also referred to herein as a gas spring assembly) and a component that is mounted on or along the gas spring using a connection formed by a cold joining process. It will be appreciated that such a component can be of any suitable size, shape, configuration and/or construction, and can be disposed along an interior or an exterior surface of an end member or other component of a gas spring assembly in any suitable manner. In some cases, the component can be secured along the exterior of a gas spring assembly, such as on an outer surface of an end member, for example, and can be dimensioned for securement to an associated structural member. In other cases, the component can be secured within the interior of a gas spring assembly, such as along a surface of an end member within the spring chamber of the gas spring assembly, for example, and can be dimensioned to retain an associated internal component within the gas spring assembly.

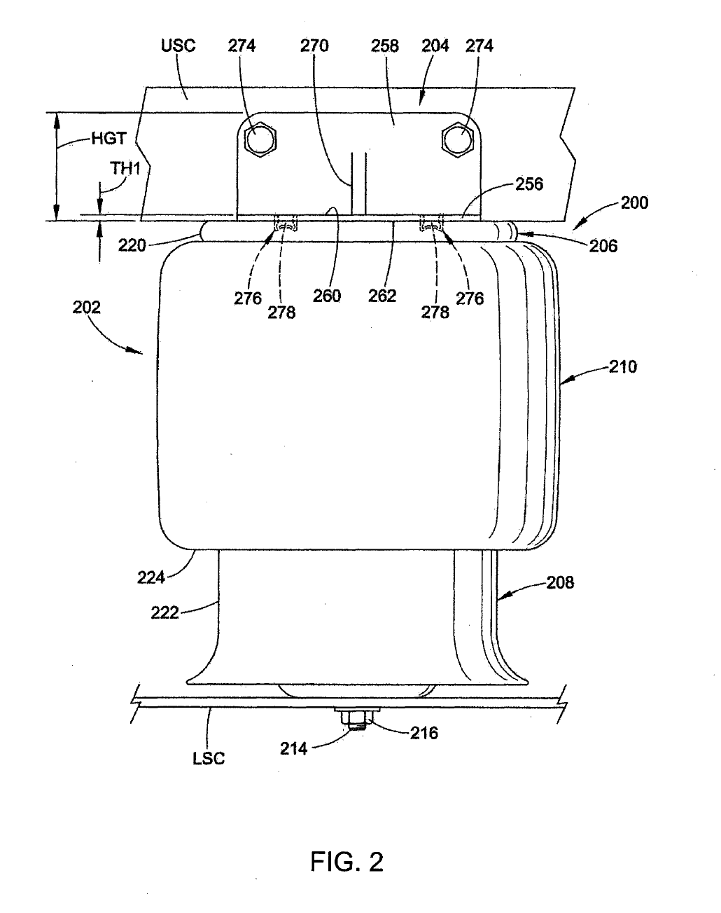

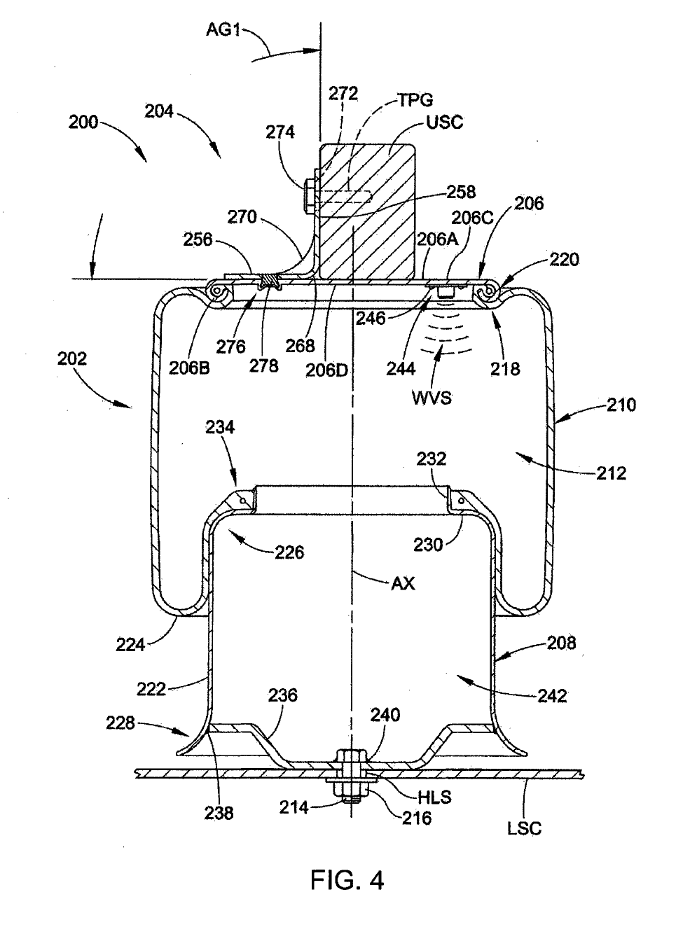

One example of a gas spring and component assembly 200 in accordance with the subject matter of the present disclosure is shown in FIGS. 2-4 as including a gas spring 202 and a component 204 that is secured thereto. Gas spring 202 is shown as having a longitudinally-extending axis AX (FIG. 4) and can include one or more end members, such as an end member 206 and an end member 208 that is spaced longitudinally from end member 206. A flexible wall 210 can extend peripherally around axis AX and can be secured between the end members in a substantially fluid-tight manner such that a spring chamber 212 (FIG. 4) is at least partially defined therebetween.

Gas spring and component assembly 200 can be disposed between associated sprung and unsprung masses of an associated vehicle in any suitable manner. For example, one end member can be operatively connected to the associated sprung mass with the other end member disposed toward and operatively connected to the associated unsprung mass. In the embodiment shown in FIGS. 2-4, for example, end member 206 is shown as being secured along a first or upper structural component USC, such as associated vehicle body BDY in FIG. 1, for example. End member 208 is shown as being secured along a second or lower structural component LSC, such as an axle AXL in FIG. 1, for example. End member 208 is shown without an associated mounting component and, thus, can be secured on or along the associated structural component in any suitable manner. As one example, lower structural component LSC could include one or more mounting holes HLS (FIG. 4) extending therethrough. In such case, a mounting stud 214 could be operatively connected to end member 208 and could extend through one of mounting holes HLS to receive a corresponding threaded nut 216, for example.

It will be appreciated that the one or more end members can be of any suitable type, kind, construction and/or configuration, and can be operatively connected or otherwise secured to the flexible wall in any suitable manner. In the exemplary arrangement shown in FIGS. 2-4, for example, end member 206 includes an end member wall 206A that extends radially outward to an outer peripheral wall portion 206B and has opposing surfaces 206C and 206D. End member 206 is shown as being of a type commonly referred to as a bead plate and is secured to a first end 218 of flexible wall 210 using a crimped-edge connection 220 in which outer peripheral wall portion 206B forms a substantially fluid-tight connection with end 218. End member 208 is shown in the exemplary arrangement in FIGS. 2-4 as being of a type commonly referred to as a piston (or a roll-off piston) and has an outer side wall 222 that abuttingly engages flexible wall 210 such that a rolling lobe 224 is formed therealong. As gas spring 202 is displaced between extended and collapsed conditions, rolling lobe 224 is displaced along outer side wall 222 in a conventional manner.

As identified in FIG. 4, end member 208 extends generally between a first or upper end 226 and a second or lower end 228. One example of a connection between the flexible wall and the end member is shown in FIG. 4 in which end member 208 includes an end wall 230 disposed along end 226 and extending transverse to axis AX. An inner side wall 232 can extend longitudinally outwardly from end wall 230 in a direction away from end 228. Flexible wall 206 can include a second end 234 that is received along inner side wall 232 such that a substantially fluid-tight seal is formed therebetween. It is to be understood, however, that the arrangement shown and described is merely exemplary and that any other suitable construction and/or configuration can alternately be used.

End member 208 can also include a bottom wall 236 that is disposed along end 228 of the end member and can be secured on or along outer side wall 222 in any manner suitable for forming a substantially fluid-tight connection, such as by using a flowed-material joint 238, for example. In some cases, mounting stud 214 can be operatively connected to bottom wall 236 in a manner suitable for forming a substantially fluid-tight seal therewith, such as by using a flowed-material joint 240, for example. Additionally, end member 208 can include a chamber 242 that is formed therein and in fluid communication with spring chamber 212. In the exemplary arrangement shown, chamber 242 is at least partially defined by outer side wall 222, end wall 230, inner side wall 232 and bottom wall 236.

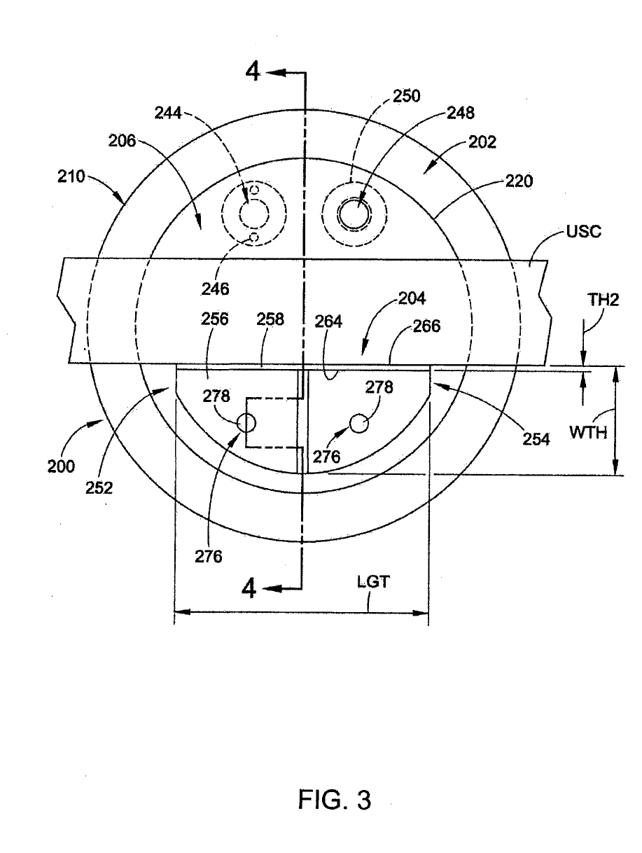

A height or distance sensing device 244 is, optionally, shown in FIGS. 3 and 4 as being disposed within spring chamber 212 along end member 206 and being secured thereto using suitable fasteners 246. Height sensing device 244 can be of any suitable type, kind and/or construction, such as an ultrasonic sensor that transmits and receives ultrasonic waves WVS (FIG. 4), for example. Additionally, it will be appreciated that height sensing device 244 can be connected to other systems and/or components of a vehicle suspension system in any suitable manner. Height sensing device 244 can include a lead or connection (not shown) that can be used for such communication purposes, such as is indicated by leads 126 of control system 120 in FIG. 1, for example.

One or more fluid communication ports, such as a transfer passage 248 (FIG. 3), for example, can optionally be included to provide or otherwise permit fluid communication with spring chamber 212, such as may be used for transferring pressurized gas into and/or out of the spring chamber, for example. In the exemplary embodiment shown, transfer passage 248 extends through a fitting connector 250 that is secured in a substantially fluid-tight manner on or along end member 206. Fitting connector can include a plurality of threads or other suitable connection features, such as may be suitable for receiving a pressurized gas transfer line (e.g., gas transfer lines 118 in FIG. 1). It will be appreciated, however, that any other suitable fluid communication arrangement could alternately be used.

As indicated above, a gas spring and component assembly in accordance with the subject matter of the present disclosure can include a gas spring, such as gas spring 202, and a component that is attached to or otherwise secured on or along an end member of the gas spring using a connection formed by a cold joining process. It will be appreciated that the component can be a component or device of any suitable type, kind and/or construction, such as sensors, valves, fluid connectors and/or electrical terminals, for example. Additionally, it will be appreciated that the component can be of any suitable size, shape, configuration and/or arrangement.

One example of such an component is identified in FIGS. 2-4 as component 204, which is shown as being an L-shaped bracket that has a length and a width, such as are respectfully represented in FIG. 3 by reference dimensions LGT and WTH, as well as a height, such as is represented in FIG. 2 by reference dimension HGT. Component 204 extends longitudinally between an end 252 (FIG. 3) and an end 254 (FIG. 3) that is spaced lengthwise from end 252. As identified in FIG. 4, component 204 is shown as including a bottom or base wall 256 and a side wall 258. Base wall 256 is shown as being generally planar, and includes a surface 260 and a surface 262 opposite surface 260 with a wall thickness defined therebetween, such as is represented in FIG. 2 by reference dimension TH1. Side wall 258 is also shown as being generally planar, and includes a surface 264 and a surface 266 opposite surface 264 with a wall thickness defined therebetween, such as is represented in FIG. 3 by reference dimension TH2. In some cases, base wall 256 and side wall 258 can be formed from a single, unitary section of material with a radiused corner or wall portion 268 (FIG. 4) integrally formed therebetween and extending lengthwise along the bracket. In such cases, thicknesses TH1 and TH2 can be approximately equal to one another. It will be appreciated, however, that other constructions and/or arrangements could alternately be used.

Side wall 258 is shown as extending from along base wall 256 and in a transverse orientation relative thereto. As such, side wall 258 can be disposed at an angle relative to base wall 256, such as is represented in FIG. 4 by reference dimension AG1, which is shown as being defined between surfaces 262 and 266. It will be appreciated that angle AG1 can have a value within any suitable range of angles. For example, angle AG1 have a value within a range of from approximately 45 degrees to approximately 135 degrees. In a preferred arrangement, side wall 258 can be disposed perpendicular to base wall 256 such that angle AG1 has a nominal value between approximately 85 degrees and approximately 95 degrees.

One or more gussets or support walls can, optionally, extend between and operatively interconnect the base wall and the side wall. For example, component 204 is shown in FIGS. 2-4 as including a support wall 270 that extends between and operatively interconnects base wall 256 and side wall 258. In some cases, the one or more support walls can be provided as separate elements that are attached or otherwise secured between the base wall and the side wall in a suitable manner, such as by way of a flowed-material joint, for example. In other cases, the one or more support walls can be integrally formed from the material from which the base and/or side walls are formed.

Additionally, the component can be secured on or along the associated structural component in any suitable manner. For example, side wall 258 can include one or more openings or holes 272 (FIG. 4) extending therethrough and through which a suitable securement device can extend to thereby secure the bracket on or along the associated structural component. In the exemplary arrangement shown, for example, upper structural component USC includes threaded passages TPG that are disposed in approximate alignment with holes 272 such that threaded fasteners 274 can extend through the holes and threadably engage the threaded passages. It will be appreciated, however, that other arrangements could alternately be used.

In accordance with the subject matter of the present disclosure, an component, such as component 204, for example, can be secured on or along an end member of the gas spring using a cold joining process. In a preferred arrangement, connections formed between the component and the end member by such cold joining processes are non-threaded threaded connections that are generally deemed to be permanent connections, such as may result in the destruction or deformation (e.g., permanent, plastic and/or substantially-inelastic deformation) of one or more components or elements rendering the same unfit for re-use. It will be appreciated that, in a preferred arrangement, that the end member and the component can be of any suitable size, shape, configuration and/or construction, and can be formed from any suitable material or combination of materials. For example, the end member and the component can each be at least partially formed from a metal material, such as steel or aluminum, for example. In a preferred arrangement, a common metal material can be used for the end member and the component, such as may be useful for providing similar or

In the exemplary arrangement in FIGS. 2-4, component 204 is shown as being secured along end member 206 using embedded fastener connections 276 that are formed along base wall 256 in spaced-apart relation to one another on opposing sides of support wall 270. In some cases, the embedded fastener connections can include self-piercing fasteners 278 that are driven through base wall 256 and into end member 206. In driving the self-piercing fasteners in this manner, the material of the base wall and the end member is upset or otherwise deformed around self-piercing fasteners 278. Additionally, the self-piercing fasteners can, in some cases, be upset or otherwise deformed during the driving action. Together, the localized deformation of at least one of base wall 256 and end member 206, as well as the optional deformation of one or more of fasteners 278, result in the formation of connections 276. In some cases, suitable self-piercing fasteners may be available from Henrob Corporation of Livonia, Mich.

It will be appreciated that action of driving the self-piercing fasteners can take place under the influence of opposing dies that can provide for or otherwise permit controlled deformation of the base wall and end member during entry of the self-piercing fasteners. Additionally, the use of opposing dies to control deformation of the end member can permit the formation of embedded fastener connections that are substantially fluid-tight, such as through formation of the connection without permitting the fasteners to pierce or otherwise breakthrough the end member. In such cases, the fasteners forming the embedded fastener connections remain fluidically isolated from the spring chamber of the gas spring. As a result, connections formed by a cold joining process, such as embedded fastener connections 276, for example, can be employed in connection with gas spring devices without generating pathways for potential pressurized gas loss.

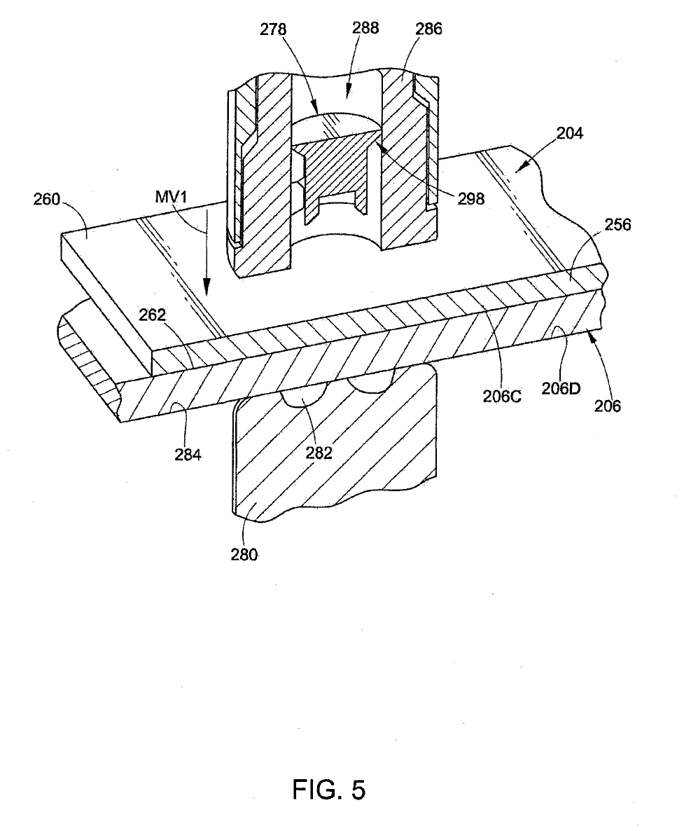

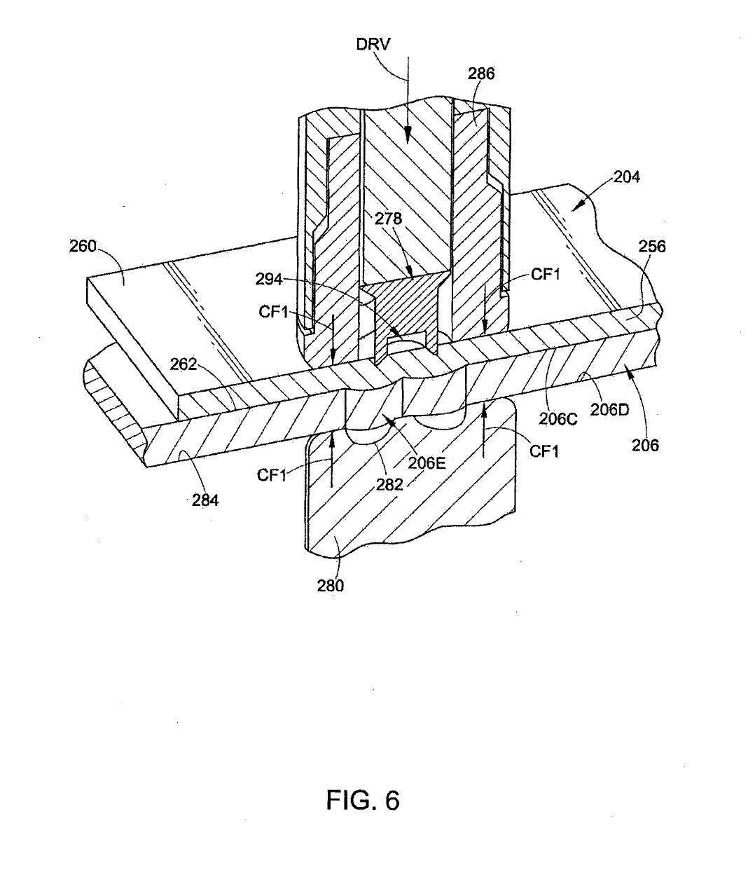

It will be appreciated that a connection formed between a gas spring and an component using a cold joining process in accordance with the subject matter of the present disclosure can be formed by any suitable method. One example of a suitable method is illustrated in FIGS. 5-10 in connection with the formation of embedded fastener connections 276, such as have been described in detail above. FIG. 5 shows base wall 256 of component 204 supported on end member 206 in a desired position and orientation prior to undergoing a cold joining process, such as the formation of embedded fastener connection 276, for example. A lower die section 280 having a die cavity 282 formed therein is disposed in abutting engagement with a surface 284 of end member 206. An upper die section 286 includes a die cavity 288 that receives and retains self-piercing fastener 278. As identified by arrows MV1 in FIG. 5, upper die section 286 is moved into abutting engagement with surface 260 of base wall 256, such that a clamping force is applied between the end member and the component, as is represented by arrows CF1 in FIG. 6.

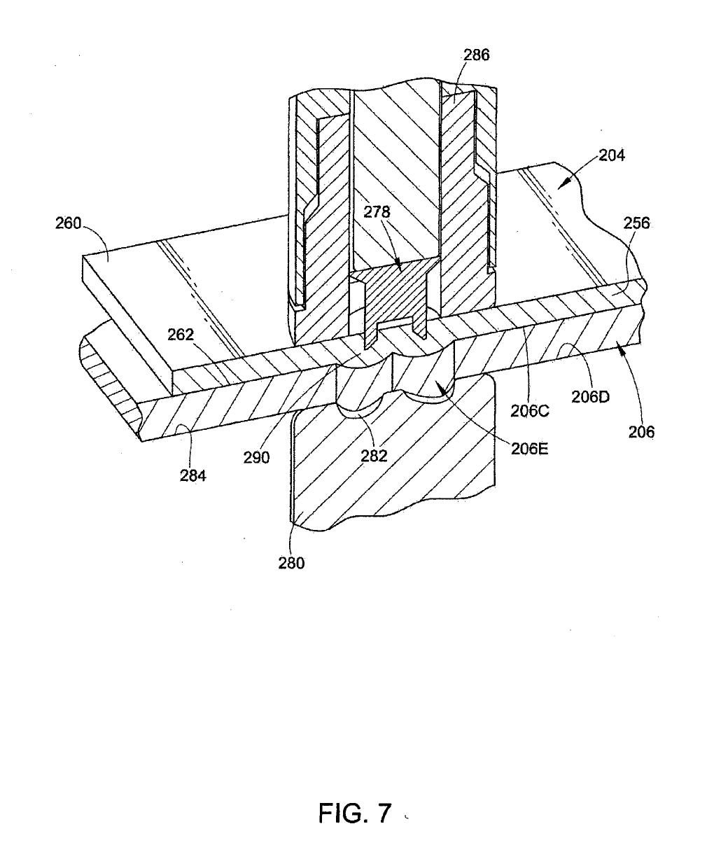

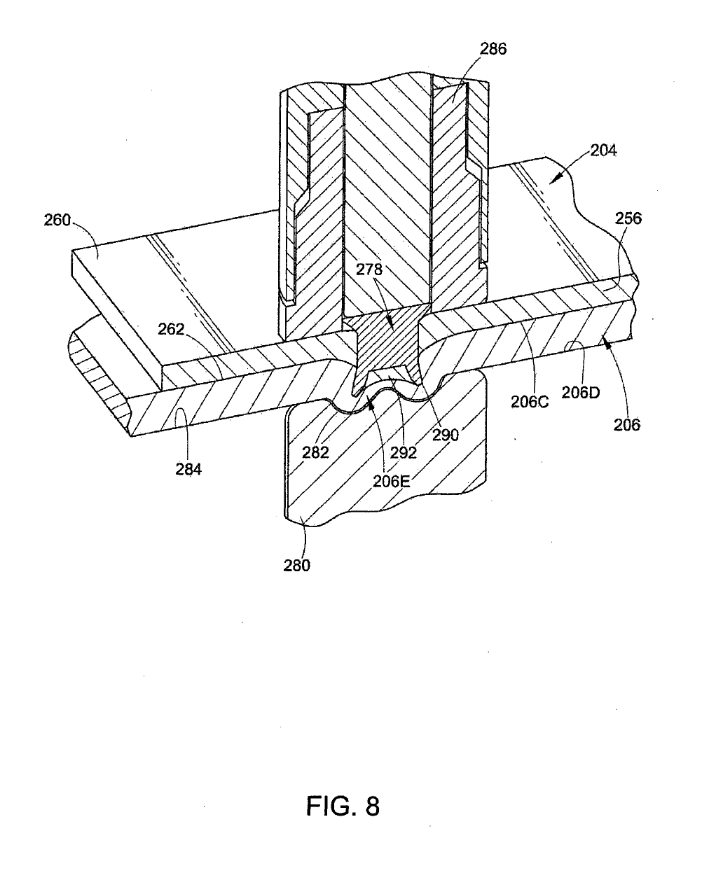

Under the influence of die sections 280 and 286, self-piercing fastener 278 is driven into engagement with base wall 256, as is represented in FIG. 6 by arrow DRV. This driving action causes an edge 290 (FIG. 7) of fastener 278 to pierce base wall 256 and results in localized deformation and/or material flow of base wall 256 and end member 206 in a direction toward lower die section 280. As illustrated in FIG. 7, fastener 278 continues to be driven into base wall 256 and material of end member 206 flows into die cavity 282 of die section 280. As illustrated in FIG. 8, fastener 278 may eventually be driven into engagement with end member 206 such that a portion 292 of base wall 256 may be severed and retained within a cavity 294 (FIG. 6) formed within fastener 278. Additionally, as die cavity 282 becomes filled with material of end member 206, edge 290 of fastener 278 can, in some cases, deform in a radially outward direction, such as is illustrated in FIGS. 8-10, for example.

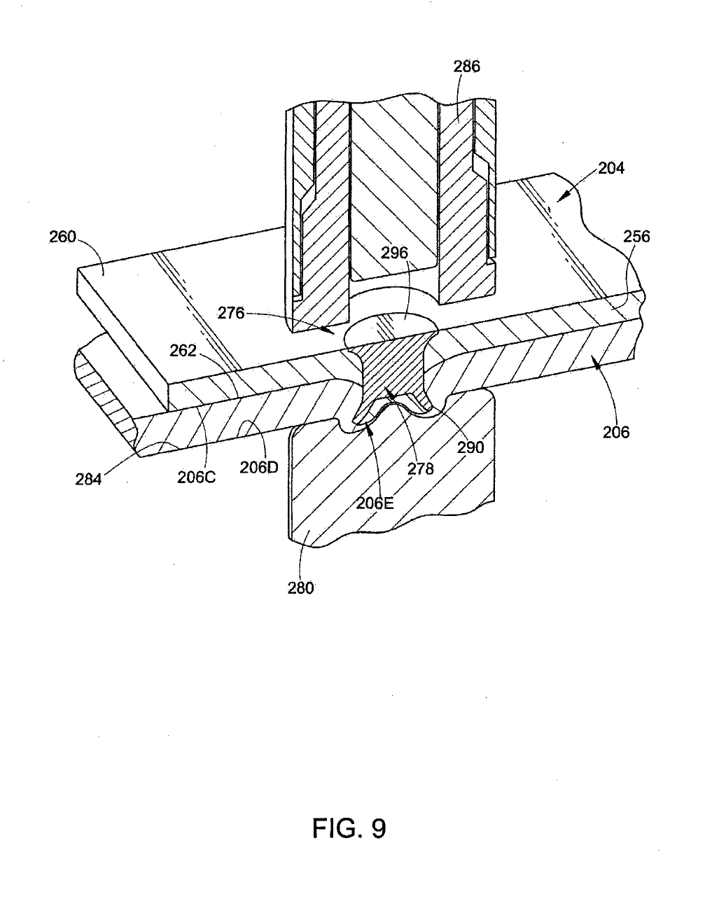

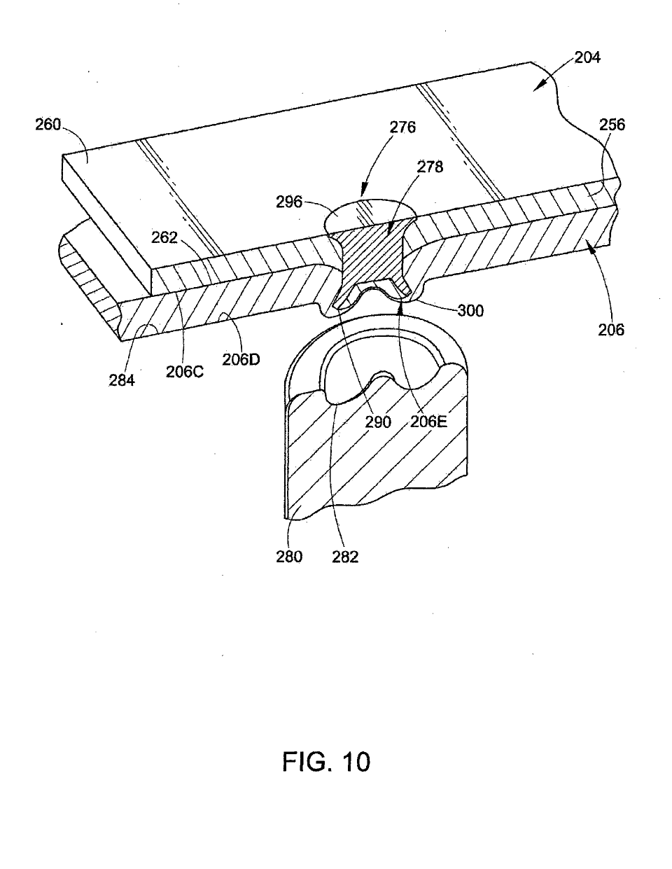

As illustrated in FIGS. 9 and 10, fastener 278 can be driven into base wall 256 and end member 206 until the fastener is substantially entirely embedded therein. In such case, an outer surface 296 of head 298 (FIG. 5) of fastener 278 can be disposed approximately flush with or otherwise in substantial alignment with surface 260 of base wall 256. At such point, die cavity 282 is substantially filled with material of end member 206 such that a substantially fluid-tight connection is formed. Additionally, edge 290 of fastener 278 has been deformed in a radially outward direction such that material of base wall 256 and end member 206 is captured between head 298 and deformed edge 290. Furthermore, a portion of one of the end member and the component can be deformed or otherwise displaced outwardly from along a surface thereof such that a projection or boss is at least partially formed by the flow of material into one or more of the die sections. For example, as portion 206E of end member 206 fills die cavity 282, a projection or boss 300 (FIG. 10) is formed along surface 206D of end member 206. Die sections 280 and 286 can be retracted from engagement with end member 206 and base wall 256, respectively, as shown in FIGS. 9 and 10.

As discussed above, it will be appreciated that gas spring and components assemblies of the present disclosure can be operatively connected between the sprung and unsprung masses of an associated vehicle in any suitable manner. For example, as shown in FIG. 1, the gas spring and component assemblies can be operatively connected between an axle AXL and body BDY of a vehicle VHC. It will be appreciated, however, that the configuration of vehicle VHC in FIG. 1 is merely a schematic representation of the structural components of the sprung and unsprung masses of the vehicle. Thus, it will be understood that this schematic representation is provided for purposes of discussion and ease of understanding and is not intended to be in any way limiting.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A gas spring and component assembly comprising:
a flexible wall having a longitudinal axis and extending peripherally about said axis between a first end and a second end spaced longitudinally from said first end, said flexible wall dimensioned to at least partially define a spring chamber;
an end member secured across said first end of said flexible wall, said end member including an end member wall with a first surface disposed toward said flexible wall and a second surface facing away from said flexible wall;
a component including a component wall with a first surface disposed along one of said first surface and said second surface of said end member; and, an embedded fastener connection formed between said end member and said component, said connection securing said end member and said component in fixed relation to one another.

2. A gas spring and component assembly according to claim 1, wherein said embedded fastener connection is at least partially formed by a cold joining process that forms a permanent connection between said end member and said component.

3. A gas spring and component assembly according to claim 1, wherein said gas spring and component assembly is dimensioned for securement along an associated structural component, and said component is disposed along said second surface of said end member and projects outwardly from along said end member for securement to the associated structural component.

4. A gas spring and component assembly according to claim 1, wherein said component is dispose along said first surface of said end member and projected into said spring chamber from along said end member.

5. A gas spring and component assembly according to claim 1, wherein said embedded fastener connection forms a substantially fluid-tight joint with at least one of said end member and said component.

6. A gas spring and component assembly according to claim 1, wherein one of said end member and said component includes a boss formed by said embedded fastener connection along a surface thereof.

7. A gas spring and component assembly according to claim 1, wherein said end member wall is at least partially formed from a first quantity of material and said component wall is at least partially formed from a second quantity of material with said first and second quantities of material being from a common family of metallic materials.

8. A gas spring and component assembly according to claim 1, wherein said embedded fastener connection includes a self-piercing fastener that is disposed in abutting engagement with at least one of said end member and said component.

9. A gas spring and component assembly according to claim 1, wherein said self-piercing fastener is fluidically isolated from said spring chamber by at least a portion of said end member wall.

10. A gas spring and component assembly according to claim 8, wherein said self-piercing fastener includes a head, a distal edge disposed in spaced relation to said head and a cavity extending into said self-piercing fastener toward said head from along said distal edge.

11. A method of assembling a gas spring and component assembly, said method comprising:
providing an end member including an end member wall with a first surface and a second surface opposite said first surface;
providing a component including a component wall formed from a quantity of material with at least a first surface;
orienting said end member and said component such that said first surface of said component wall is disposed along one of said first surface and said second surface of said end member wall; and,
forming an embedded fastener connection between said end member and said component and thereby securing said end member and said component in fixed relation to one another.

12. A method according to claim 11, wherein forming an embedded fastener connection includes forming a substantially fluid-tight joint with at least one of said end member and said component.

13. A method according to claim 11, wherein forming an embedded fastener connection includes:
providing a self-piercing fastener that includes a head and a distal edge;
clamping said end member and said component in fixed relation to one another; and,
driving said self-piercing fastener into said end member wall and said component wall such that is said self-piercing fastener is disposed in abutting engagement with at least one of said end member and said component.

14. A method according to claim 13, wherein forming an embedded fastener connection includes positioning a die section along one surface of said end member and a die section along one surface of said component, and clamping said end member and said component in fixed relation to one another using said die sections.

15. A method according to claim 13, wherein forming an embedded fastener connection includes providing a die section that includes a die cavity and deforming material of at least one of said end member wall and said component wall into said die cavity to form boss projecting outward from a surface of one of said end member wall and said component wall.

16. A method according to claim 11 further comprising:
providing a flexible wall having a longitudinal axis and extending peripherally about said axis between a first end and a second end spaced longitudinally from said first end, said flexible wall dimensioned to at least partially define a spring chamber; and,
securing said end member along said first end of said flexible wall such that a substantially fluid-tight connection is formed therebetween.

17. A method of assembling a suspension system comprising:
providing at least one structural member;
providing a gas spring and component assembly according to claim 1;
positioning said end member of said gas spring and component assembly adjacent said at least one structural member; and,
securing at least said component of said gas spring and component assembly to said at least one structural member.
